(19) United States
(12) Patent Application Publication
(10) Pub. No.: US 2024/0323718 A1
(43) Pub. Date: Sep. 26, 2024

(54) Method of Self Optimization of Fast Master Cell Group Recovery

(71) Applicant: ZTE Corporation, Shenzhen (CN)

(72) Inventors: Dapeng LI, Shenzhen (CN); Yin GAO, Shenzhen (CN); Zhuang LIU, Shenzhen (CN); Jiren HAN, Shenzhen (CN)

(73) Assignee: ZTE Corporation, Shenzhen, GD (CN)

(21) Appl. No.: 18/677,574

(22) Filed: May 29, 2024

Related U.S. Application Data
(63) Continuation of application No. PCT/CN2022/110946, filed on Aug. 8, 2022.

(51) Int. Cl. H04W 24/04; H04W 24/02

(52) U.S. Cl. CPC H04W 24/04; H04W 24/02

(57) ABSTRACT

This disclosure relates to a mechanism for inter-node communications for facilitating fast link failure recovery and for enabling self-optimization of network nodes in response to link failures. For example, in a dual connectivity scenario, a radio link from a terminal device to a master access network node associated with a mater cell group may fail. During a subsequent information exchange for implementing a fast link recovery procedure, the information exchange path via a secondary access network node may also fail under various network conditions along such a path. Various example implementations are disclosed for reporting such interrupting network conditions to the various relevant network nodes such that these network nodes are informed of the network conditions and are provided with an opportunity to perform self-optimization of network configurations in order to reduce a likelihood of interruption to any future fast radio link recovery procedures.

### TECHNICAL FIELD

This disclosure is generally directed to wireless communication systems and methods and relates particularly to a mechanism for inter-node communications for facilitating fast link failure recovery and for enabling self-optimization of network nodes in response to link failures.

### BACKGROUND

In wireless access network, radio links may fail at times. Fast recovery from radio link failures is critical to the overall performance of the wireless access network. Such recovery begins on accurate detection of link failures. A detected radio link failure information must be exchanged among the various network nodes in order to effectuate a fast radio link failure recovery. Such information exchanges, in turn, rely on various communication interfaces and communication channels between the network nodes. These interfaces may themselves fail due to various reasons, thereby interrupting the recovery of the radio link failure in the first place. Such interface failures should also be detected and reported to the relevant network nodes in order to enable self-optimization of configurations in these network nodes for reducing future failures.

### SUMMARY

This disclosure is generally directed to wireless communication systems and methods and particularly relates to a mechanism for inter-node communications for facilitating fast link failure recovery and for enabling self-optimization of network nodes in response to link failures. For example, in a dual connectivity scenario, a radio link from a terminal device to a master access network node associated with a mater cell group may fail. During a subsequent information exchange for implementing a fast link recovery procedure, the information exchange path via a secondary access network node may also fail under various network conditions along such a path. Various example implementations of reporting and communication schemes are disclosed for reporting such interrupting network conditions to the various relevant network nodes such that these network nodes are informed of the network conditions and are provided with an opportunity to perform self-optimization of network configurations in order to reduce a likelihood of interruption to any future fast radio link recovery procedures.

In some example implementations, a method performed by a wireless terminal device in communication with a Master Node (MN) associated with a Master Cell Group (MCG) and a Secondary Node (SN) associated with a Secondary Cell Group (SCG) is disclosed. The method may include instantiating a fast MGC failure recovery mode in response to receiving an MCG failure recovery configuration from the MN; detecting an MCG radio link failure; determining a no-MN-response condition associated with informing the MN of the MCG radio link failure via the SN; generating a reporting data structure associated with the MCG link failure and the no-MN-response condition; and transmitting the reporting data structure to an intermediary wireless access network node relaying the MCG link failure and the no-MN-response condition to the MN or the SN.

In any of the example implementations above, the no-MN-response condition may include a detection of a SCG radio link failure between the wireless terminal device and the SN prior to the wireless terminal device successfully informing the SN of the MCG radio link failure.

In any of the example implementations above, the reporting data structure may include at least one of: a first cell identification of the MN; a second cell identification of the SN; a first failure information associated with the MCG radio link failure; or a second failure information associated with the SCG radio link failure.

In any of the example implementations above, the reporting data structure is transmitted to the intermediate wireless access network node via a Radio Resource Control (RRC) message.

In any of the example implementations above, the first failure information comprises at least one of an MCG link failure type or a list of MCG frequency measurements.

In any of the example implementations above, the second failure information may include at least one cell measurement associated with the SN.

In any of the example implementations above, the reporting data structure is included as an Information Element (IE) in a UE Radio Link Failure (RLF) report message.

In any of the example implementations above, the reporting data structure is included in the UE RLF report message as a container.

In any of the example implementations above, the reporting data structure is included a fast MCG link recovery report message separate from a UE RLF report message.

In any of the example implementations above, the no-MN-response condition may include a detection of an SCG radio link failure between the wireless terminal device and the SN after the wireless terminal device successfully informing the SN of the MCG radio link failure.

In any of the example implementations above, the reporting data structure may include an indication that the wireless terminal device has successfully informed the SN of the MCG radio link failure; and at least one of: a first cell identification of the MN; a second cell identification of the SN; a first failure information associated with the MCG radio link failure; or a second failure information associated with the SCG radio link failure.

In any of the example implementations above, the reporting data structure is transmitted to the intermediate wireless access network node via a Radio Resource Control (RRC) message.

In any of the example implementations above, the first failure information may include at least one of an MCG link failure type or a list of MCG frequency measurements and the second failure information comprises at least one cell measurement associated with the SN.

In any of the example implementations above, the reporting data structure is included as an Information Element (IE) or a container in a UE Radio Link Failure (RLF) report message; or a fast MCG link recovery report message separate from the UE RLF report message.

In any of the example implementations above, the MCG failure recovery configuration comprises a timer having a preconfigured time length; the method further comprising transmitting a failure message indicating the MCG radio link failure to the SN; and the no-MN-response condition comprises an expiration of the timer prior to receiving a response to the failure message from the MN.

In any of the example implementations above, the reporting data structure may include an indication that the timer has expired; and at least one of: a first cell identification of the MN; a second cell identification of the SN; a failure information associated with the MCG radio link failure; or a cell measurement of the SN upon the expiration of the timer.

In any of the example implementations above, the reporting data structure is transmitted to the intermediary wireless access network node via a Radio Resource Control (RRC) message.

In any of the example implementations above, the failure information comprises at least one of an MCG link failure type or a list of MCG frequency measurements.

In any of the example implementations above, the reporting data structure is included as an Information Element (IE) or a container in a UE Radio Link Failure (RLF) report message; or a fast MCG link recovery report message separate from the UE RLF report message.

In some other implementations, a method performed by a wireless access network node in assisting a wireless terminal device with reporting a link failure condition, the wireless terminal device being in communication with a Master Node (MN) associated with a Master Cell Group (MCG) and a Secondary Node (SN) associated with a Secondary Cell Group (SCG). The method may include receiving from the wireless terminal device a link failure reporting data item, the link failure reporting data item indicating at least one of an MCG radio link failure associated with a radio communication path between the wireless terminal device and the MN or a no-MN-response condition associated with informing the MN of the MCG radio failure via the SN by the wireless terminal device; and informing the MN or the SN of the MCG radio link failure or the no-MN-response condition.

In any of the example implementations above, the no-MN-response condition may include a detection of a SCG radio link failure between the wireless terminal device and the SN prior to the wireless terminal device successfully informing the SN of the MCG radio link failure.

In any of the example implementations above, the link failure reporting data item comprises at least one of: a first cell identification of the MN; a second cell identification of the SN; a first failure information associated with the MCG radio link failure; or a second failure information associated with the SCG radio link failure.

In any of the example implementations above, the first failure information may include at least one of an MCG link failure type or a list of MCG frequency measurements and the second failure information comprises at least one cell measurement associated with the SN.

In any of the example implementations above, the link failure reporting data item is included as: an Information Element (IE) or a container in a UE Radio Link Failure (RLF) report message; or a fast MCG link recovery report message separate from the UE RLF report message.

In any of the example implementations above, the no-MN-response condition may include a detection of an SCG radio link failure between the wireless terminal device and the SN after the wireless terminal device successfully informing the SN of the MCG radio link failure.

In any of the example implementations above, the link failure reporting data item may include an indication that the wireless terminal device has successfully informed the SN of the MCG radio link failure; and at least one of: a first cell identification of the MN; a second cell identification of the SN; a first failure information associated with the MCG radio link failure; or a second failure information associated with the SCG radio link failure.

In any of the example implementations above, the first failure information may include at least one of an MCG link failure type or a list of MCG frequency measurements and the second failure information comprises at least one cell measurement associated with the SN.

In any of the example implementations above, the no-MN-response condition may include an expiration of a timer at the wireless terminal device having a preconfigured time length prior to the wireless terminal device receiving a response from the MN to a failure message sent by the wireless terminal device to the SN for indicating to the SN the MCG radio link failure.

In any of the example implementations above, the link failure reporting data item may include an indication that the timer has expired; and at least one of: a first cell identification of the MN; a second cell identification of the SN; a failure information associated with the MCG radio link failure; or a cell measurement of the SN upon the expiration of the timer.

In any of the example implementations above, informing the MN or the SN of the MCG radio link failure or the no-MN-response condition may include informing the MN of the MCG radio link failure and the no-MN-response condition; and enabling the MN to inform the SN of at least the no-MN-response condition.

In any of the example implementations above, informing the MN or the SN of the MCG radio link failure or the no-MN-response condition may include informing the MN of the MCG radio link failure and the no-MN-response condition; and separately informing the SN of at least the no-MN-response condition.

In some other implementations, a wireless device comprising a processor and a memory is disclosed. The processor may be configured to read computer code from the memory to implement any one of the methods above.

In yet some other implementations, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2A illustrates an example 5G wireless access network nodes in communication with a core network.

FIG. 2B illustrates an example wireless access network including a plurality of mobile stations or UEs and a wireless access network node in communication with one another via an over-the-air radio communication interface.

FIG. 3 illustrates a split-architecture for separating a wireless access network node into a central unit (CU) and one or more distributed units (DUs).

FIG. 4 shows a data and logic flow for an example MCG link recovery procedure.

FIG. 5 shows a data and logic flow for handling an example exception condition in a link recovery procedure.

FIG. 6 shows a data and logic flow for handling another example exception condition in a link recovery procedure.

FIG. 7 shows a data and logic flow for handling another example exception condition in a link recovery procedure.

FIG. 8 shows a data and logic flow for handling yet another example exception condition in a link recovery procedure.

### DETAILED DESCRIPTION

The technology and examples of implementations and/or embodiments described in this disclosure can be used to facilitate radio link failure recover procedure and to improve self-optimization of network configuration in order to facilitate more efficient radio link failure recovery or to reduce occurrence of radio link failures in the first place. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is generally directed to wireless communication systems and methods and particularly relates to a mechanism for inter-node communications for facilitating fast link failure recovery and for enabling self-optimization of network nodes in response to link failures. For example, in a dual connectivity scenario, a radio link from a terminal device to a master access network node associated with a mater cell group may fail. During a subsequent information exchange for implementing a fast link recovery procedure, the information exchange path via a secondary access network node may also fail under various network conditions along such a path. Various example implementations of reporting and communication schemes are disclosed for reporting such interrupting network conditions to the various relevant network nodes such that these network nodes are informed of the network conditions and are provided with an opportunity to perform self-optimization of network configurations in order to reduce a likelihood of interruption to any future fast radio link recovery procedures.

### Wireless Network Overview

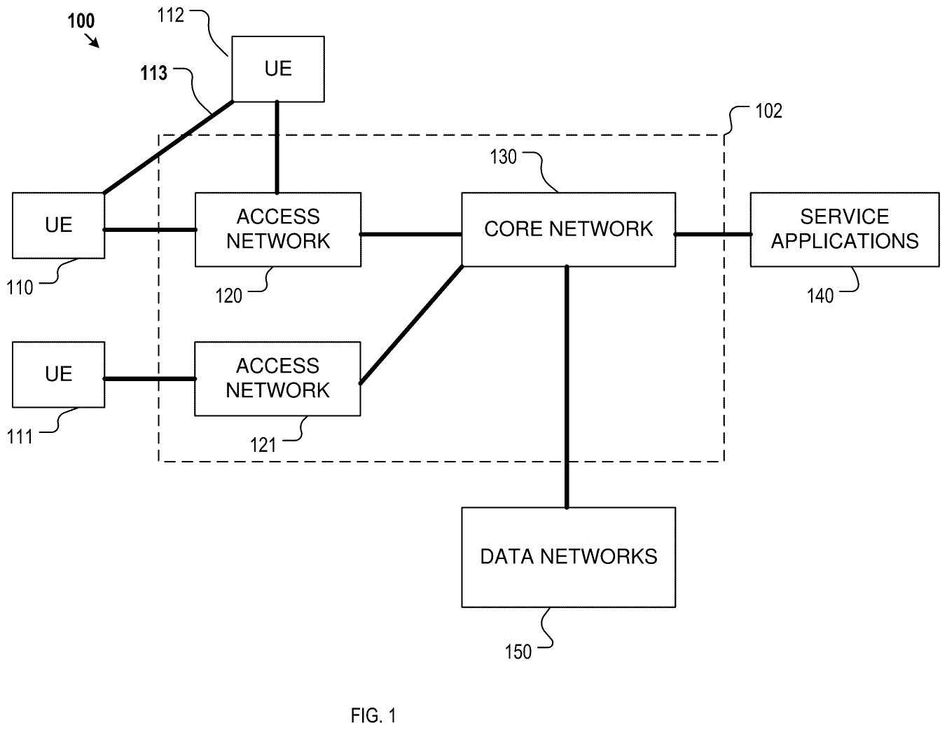

An example wireless communication network, shown as 100 in FIG. 1, may include wireless terminal devices or user equipment (UE) 110, 111, and 112, a carrier network 102, various service applications 140, and other data networks 150. The carrier network 102, for example, may include access networks 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access networks 120 and 121 may be configured as various wireless access network nodes (WANNs, alternatively referred to as base stations) to interact with the UEs on one side of a communication session and the core network 130 on the other. The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the wireless communication network of 100 of FIG. 1, the UEs may communicate with one another via the wireless access network. For example, UE 110 and 112 may be connected to and communicate via the same access network 120. The UEs may communicate with one another via both the access networks and the core network. For example, UE 110 may be connected to the access network 120 whereas UE 111 may be connected to the access network 121, and as such, the UE 110 and UE 111 may communicate to one another via the access network 120 and 121, and the core network 130. The UEs may further communicate with the service applications 140 and the data networks 150 via the core network 130. Further, the UEs may communicate to one another directly via side link communications, as shown by 113.

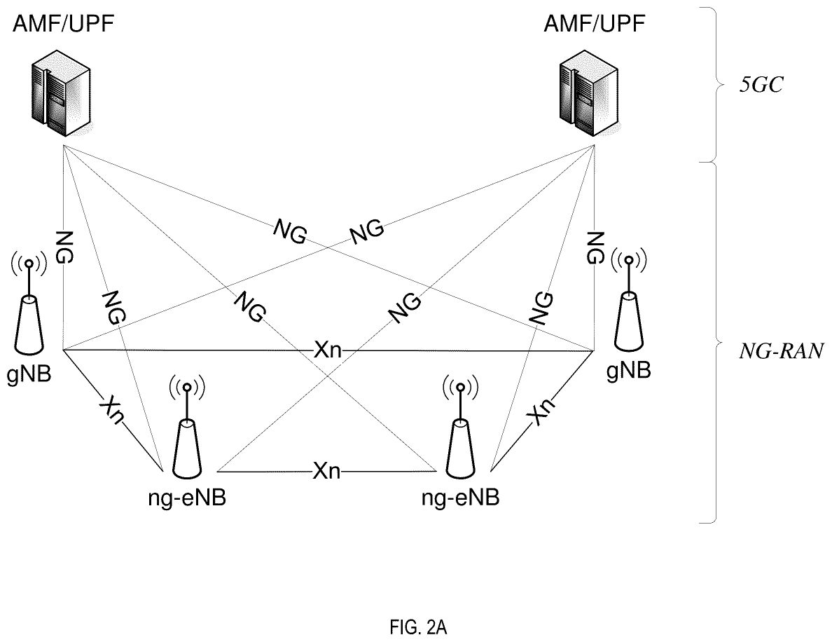

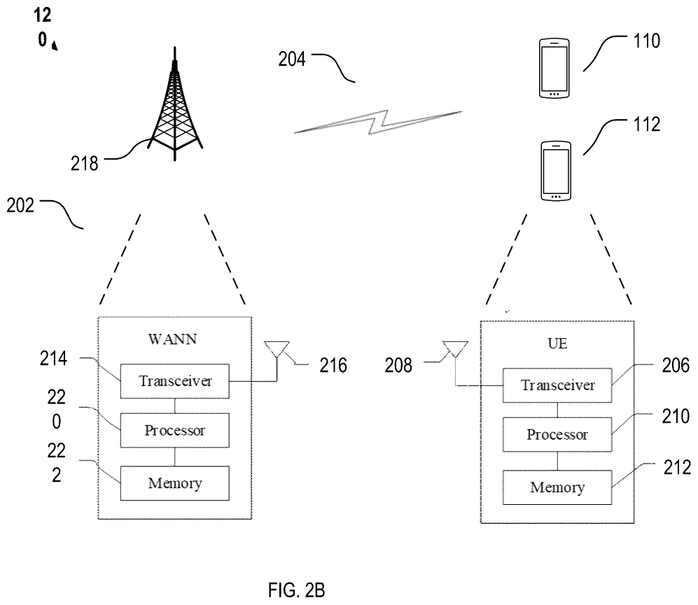

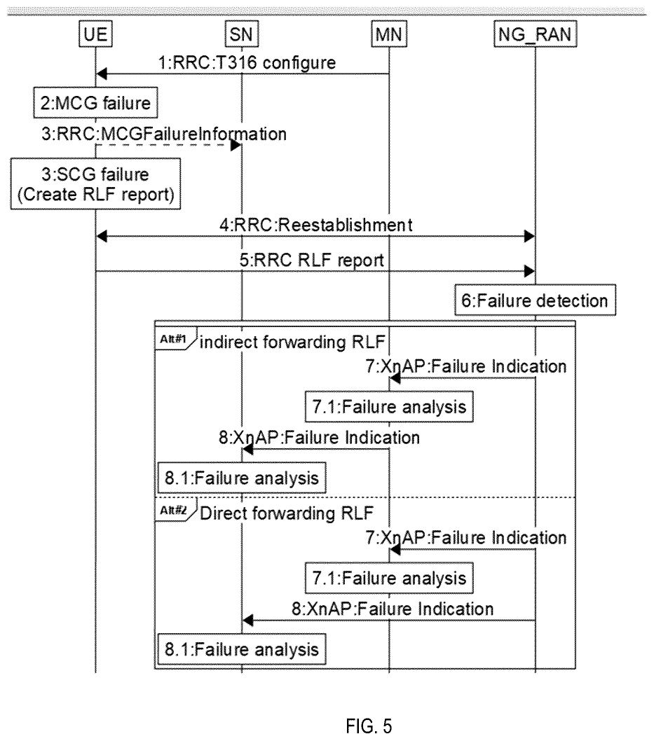

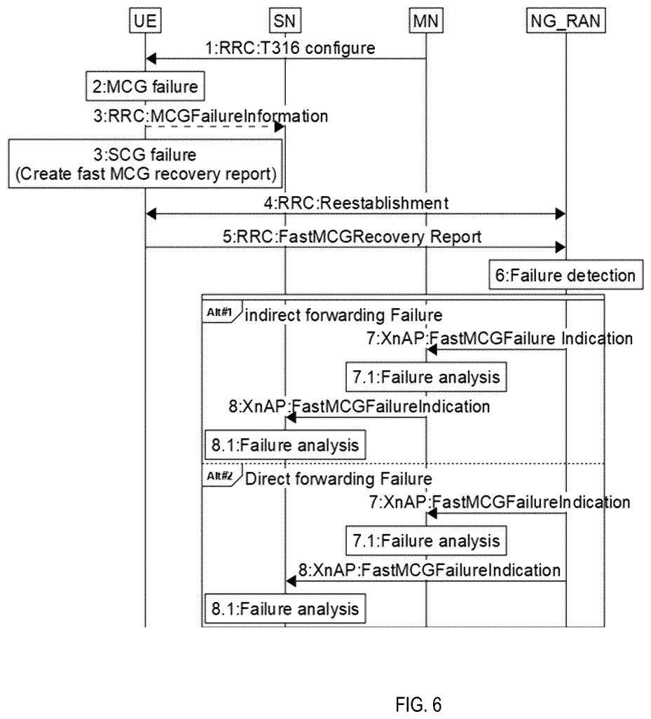

FIG. 2A illustrates system diagram of an example 5G wireless access network and its communication interface with the core network via the AMF (Access/Mobility management Function) in a control-plane and UPF (User-Plane Function) in a user plane. More details for the core network functions of the AMF and UPF are further provided below in relation to FIGS. 5 and 6. FIG. 2 shows example wireless access network nodes in the forms of gNBs and ng-eNBs. These wireless access network nodes may communicate with one another via a terrestrial Xn interface and may communicate with the AMF or UPF via an NG interface.

FIG. 2B further shows an example system diagram of the wireless access network 120 including a WANN 202 serving UEs 110 and 112 via the over-the-air interface 204. The term over-the-air interface may be interchangeably referred to as air-interface, or radio interface, and the like. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

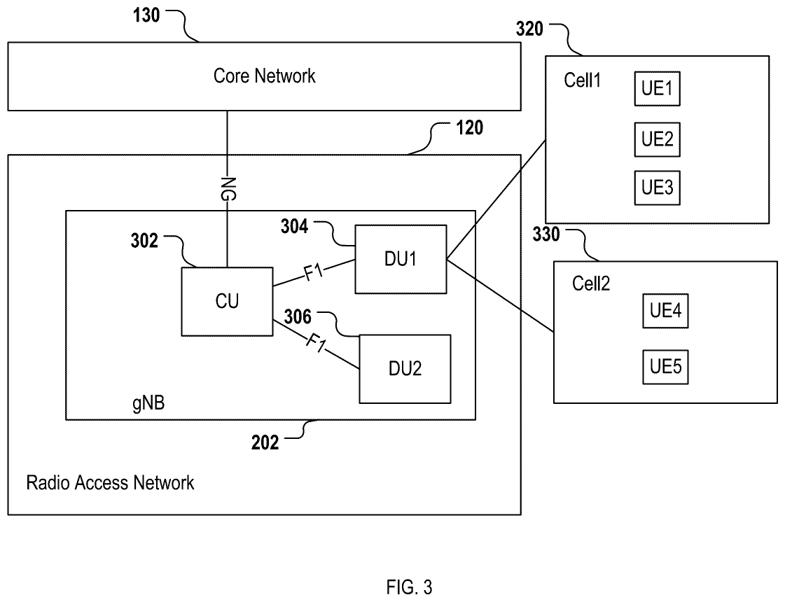

As shown in FIG. 3, one or more base stations 202 of the WANN 120, for example, may include multiple separate access network nodes in the form of a Central Unit (CU) 302 and at least one Distributed Unit (DU) 304 and 306. In a 5G network, for example, a base station may be implemented as a gNB. Correspondingly, a gNB 202 may functionally and/or physically include a gNB-CU 302 and one or more gNB-DUs 304 and 306. For example, a CU may be configured to provide support of higher layers of the communication protocols such as Service Data Adaptation Protocol (SDAP), Packet Data Convergence Protocol (PDCP), and Radio Resource Control (RRC) while a DU may be configured to provides support the lower layers of the protocol stack such as Radio Link Control (RLC), Medium Access Control (MAC) and Physical layer.

In some implementations, as shown in FIG. 3, the CU 302 may be connected with DU1 304 and DU2 306 via various FI interface. The gNB 202, for example, may be connected to the core network 130 via an NG interface. When the gNB is separated as CU and DUs, the NG connection to the core network may be implemented between the CU 302 and the core network, as shown in FIG. 3. As further shown in FIG. 3, the UEs may be connected to the core network 130 via the WANN 120 over a radio interface.

As further shown in 320 and 330 of FIG. 3, each of the DUs may serve the UEs via one or more cells. Each cell is associated with a coverage area. These cells may be alternatively referred to as serving cells. The coverage areas between cells may partially overlap. Each UE may be actively communicating with at least one cell while may be potentially connected or connectable to more than one cell. In the example of FIG. 3, UE1, UE2, and UE3 may be served by cell 1 320 of the DU1, whereas UE4 and UES are served by cell2 330 of the DU1. In some implementations, a UE may be served simultaneously by two or more cells. Each of the UE may be mobile and the signal strength and quality from the various cells at the UE may depend on the UE location. In some embodiments, the CU may be a gNB Central Unit (gNB-CU), and the DU may be a gNB Distributed Unit (gNB-DU). While the various implementations described below are provided in the context of a 5G cellular wireless network, the underlying principles described herein are applicable to other types of radio access networks including but not limited to other generations of cellular network, as well as Wi-Fi, Bluetooth, ZigBee, and WiMax networks.

In some example implementations, the cells shown in FIG. 3 may be alternatively referred to as serving cells. The serving cells may be grouped into serving cell groups (CGs). A serving cell group may be either a Master CG (MCG) or Secondary CG (SCG). Within each type of cell groups, there may be one primary cell and one or more secondary cells. A primary cell in a MSG, for example, may be referred to as a PCell, whereas a primary cell in a SCG may be referred to as PScell. Secondary cells in either an MCG or an SCG may be all referred to as SCell. The primary cells including PCell and PScell may be collectively referred to as spCell (special Cell). All these cells may be referred to as serving cells or cells. The term “cell” and “serving cell” may be used interchangeably in a general manner unless specifically differentiated. The term “serving cell” may refer to a cell that is serving, will serve, or may serve the UE. In other words, a “serving cell” may not be currently serving the UE. While the various embodiment described below may at times be referred to one of the types of serving cells above, the underlying principles apply to all types of serving cells in both types of serving cell groups.

### Self-Configuration and Self-Optimization of Access Network Nodes

In a wireless access network such as the one described above, new access network nodes may be added in an already deployed network system. In some implementations, such newly added access network node, such as eNB in LTE or gNB in NR (New Radio) may go through a self-configuration. For example, such self-configuration process may involve a procedure where newly deployed access network nodes are configured by automatic installation procedures to get the necessary basic configuration for system operation. Such basic configuration may involve configuration of various network parameters and execution of various network functions related to:
Hardware and software installation
Transport network discovery (IP addresses, setup QoS parameters and interfaces, etc.)
Automatic Neighbor Discovery (AND)
Radio parameter configuration (handover, selection-reselection, power settings, etc.)
Mobility Load Balancing
Power saving.

The various parameters settings determined through the self-configuration during the initial deployment for the newly added access network node may later be improved in the self-optimization process in response to various network conditions, such as link failures. The self-optimization process of a particular access network node may rely on reports and information that may be communicated via other access network nodes (also referred to as intermediary access network nodes). For example, neighboring nodes of a particularly access network nodes may function as an intermediary node. As such, an access network node may maintain a list of its neighbors for link failure and for self-optimization. Discovery of neighboring access network nodes may be achieved van an ANRF (Automatic Neighbor Relation Function). The ANRF function, for example, may be assisted by mobile terminals connected to the access network mode relying on a capability of a mobile terminal to send to its serving eNB the Physical Cell Identity (PCI) of the cells it senses. The serving cell can then request from the mobile terminal to send a Global Cell Identity (GCI) of the sensed eNB or gNB, and once it receives this information, it can decide to add this sensed cell and the access network node associated thereof to its neighboring list. In a self-optimization process, the neighboring cell list can be updated to follow the evolution of the network.

Self-optimization may be triggered by radio link failures, or by, as described in further detail below, communication interruption or failures in reporting the radio link failures to relevant network nodes. The various implementations below are aimed reducing such interruptions and thus enable timely and efficient self-optimization of the network configurations of the network access nodes that are potentially at issue. While the particular examples below are provided in the context of dual connectivity (DC) in a wireless access network, the underlying principles are applicable to other network connectivity situations.

### FAST MCG Radio Link Recovery Procedure

In an example dual connectivity implementation, a mobile terminal device, or a UE may be connected to a master node (MN) and a secondary node (SN). The MN may be associated with a master cell group (MCG) supporting multiple serving cells including its primary cell and secondary cells. Likewise, the SN may be associated with a secondary cell group (SCG) supporting multiple serving cells including its primary cell and secondary cells.

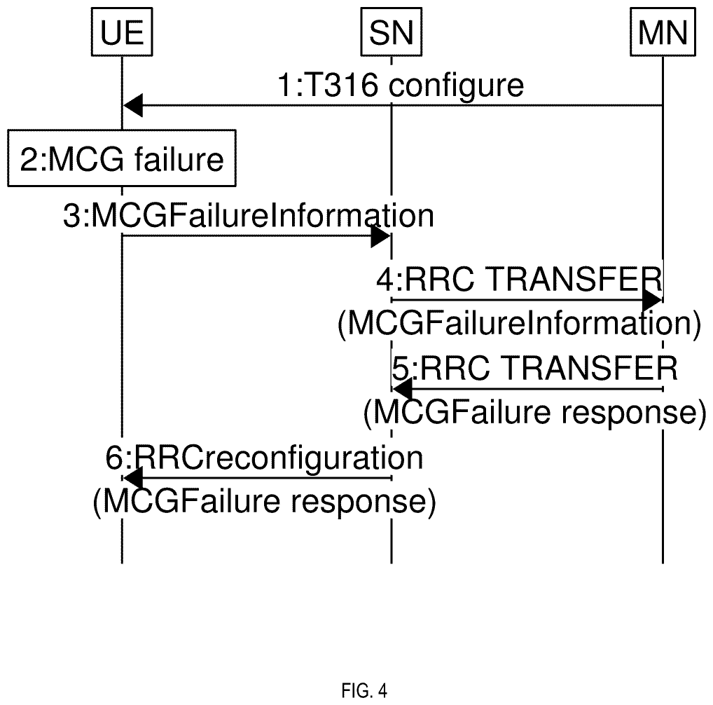

During communications of the UE with the access network, its radio link with the MCG may fail. Such a radio link failure (RLF) may be detected by the UE by, for example, determining that the radio signal from the MCG is lost or is below a minimum threshold level. The MN may not be aware of such RLF. As a result of such detection of an MCG radio link failure, a fast link recovery procedure may be initiated, as shown by the example data and logic flow of FIG. 4.

In FIG. 4, in the dual connectivity context, the fast MCG link recovery procedure may be designed for the UE to inform the MN about the RLF if the MCG via the SN. In some implementations, as shown as Step 1 in the data and logic flow of FIG. 4, a fast MCG link recovery mode may first be configured. As an example, during the link configuration (prior to the RLF with the MCG), the UE may be configured by the MN in the fast MCG link recovery mode such that the UE would perform the fast MCG link recovery procedure following steps 3-6 as illustrated in FIG. 4. Such configuration may be transmitted as a control signal from MN to the UE. Such signaling, for example, may be provided in the form of a timer (e.g., T 316 timer as indicated in FIG. 4) for triggering fast MCG link recovery upon RLF on MCG. Such a timer may be started or set to run once the MCG RLF is detected at step 2 of FIG. 4 at the UE.

Then, as shown in Steps 3 and 4, the UE may transmit an MCGFailureInformation message to the MN via the SN (via the radio link between the UE and the SN, and then the Xn interface between the SN and MN). The UE may stop the timer T 316 if a response message can be received from MN via SN as shown by Steps 5 and 6. The MCGFailureInformation, for example, may be transmitted as an RRC message. The response message, for example, may be implemented as an RRCRelease message, an RRCReconfiguration message with reconfigurationwithSync for the PCell, an MobilityFromNRCommand, or a handover commend. Then following such response, the UE may perform handover procedure if the handover command is received. However, if the timer T 316 expires prior to the UE receiving the response from the MN, UE may then perform a link re-establishment procedure.

In some implementations, the UE may also perform the link re-establishment upon detecting RLF with the SN with respect to the SCG while the T 316 timer is running. But that would mean stopping the fast MCG link recovery procedure and resorting to link re-establishment.

In some other implementations as described below, the fast link recovery process and the failure information exchange among the various network nodes may experience issues. As such, the failure information may be lost and that the various network nodes may not be informed of such failure information/conditions. As a consequence, these network nodes would not have proper basis to effectively perform self-optimization. The conditions that causes these issues may ultimately result in no-response being received from the MN by the UE after the transmission of the MCGFailureInformastion at step 3. Such conditions are thus referred to as no-MG-response conditions. Example mechanisms are further provided below to ensure that when fast MCG link recovery procedure experience such no-MN-response conditions, the system should nevertheless be able to provide the failure information with errors to the network entities or nodes where relevant error(s) occur(s) (e.g., the MN node or the SN node) for optimization analysis. Such optimization, once performed based on properly communicated failure/error information, would effectively reduce the probability that a next future fast MCG link recovery procedure would fail again.

### Example Embodiment 1

In some circumstances, the SCG link or the SN may fail during the fast MCG link recovery. Such SCG or SN failure, for example, may occur before the UE had a chance to successfully send the MCG MCGFailureInformation successfully to the SN in step 3 of FIG. 4. Such SCG or SN failure may be detected by the UE based on SCG cell measurements. It may alternatively be determined by the UE when it fails to receive an ACK from the SN with respect to the MCGFailureInformation message. In such situations, an example mechanism as shown in FIG. 5 may be implemented in order to deliver such failure information to the SN so that the SN can timely perform proper self-optimization.

Specifically, in FIG. 5, the fast MCG link recovery triggering configuration in step 1 is similar to that in FIG. 4 (e.g., by using the T 316 timer via an RRC configuration message from the MN). Once the MCG radio link failure is detected in step 2, the UE may generate a record in a VarRLF-Report variable of the UE (referred to as the RLF report). If the MCG failure is prior to an expiration of the T 316 timer, then the UE further prepares the MCFailureInformation to be sent to the MN via the SN as part of step 3.

However, the SCG or SN may fail in the meanwhile. As a result, the MCGFailureInformation message would not be deliverable to the SN. The UE may either detect the SCG link failure before sending the MCGFailureInformation message, or is not able to confirm an ACK after sending the MCGFailureInformation message to the SN (as indicated by the dashed rather than solid arrow at part of step 3 of FIG. 5). In either case, the SCG now as part of step 3 further prepares a set of information items associated with the SCG or SN failure for the purpose of sending these information items to the SN via some other intermediary network node.

For example, the UE may generate a new RLF report, or overwrite the previously generated RLF report generated in Step 2, and record both the MCG and the SCG or SN failure information in the VarRLF-Report variable of the UE.

In some example implementations, RLF report generated at step 3 may contain at least one of the following information:
1: Cell information of the failed MN (e.g., identifier information the primary cell of the MCG, referred to as failedPCellId);
2: Information of the failed SN cell (e.g., identifier information of the primary cell in the SCG, referred to as failedPScellID);
3: MCGFailureInformation information, information associated with the MCG failure, such as a type of the MCG link failure, referred to as failureType, carrier frequency information or measurement result for each individual frequency, referred to as measResultFreqList information, and the like;
4: SN cause value for radio link failure for indicating the SCG failure type, referred to as SCGfailureType; or
5: SCG PScell measurement information in case of SCG failure, referred to as MeasResultSCG-Failure.

These information items, individually or in combination are included in the RLF report to the extent that they will later be used as a basis for the various network nodes to perform self-optimization.

In step 4, the UE may select an intermediary access network node for RRC reestablishment in order convey the RLF report to the MN and SN. Specifically, the UE may initiate the RRC reestablishment flow after Step 3 to connect to the proper access network node, denoted as NG_RAN in FIG. 5. In some implementations, the UE may select a suitable NG_RAN cell according to the signal coverage situation (e.g., select an NG_RAN with the best radio link), and may then trigger an RRC reestablishment (or RRC connection) flow, and establishes the RRC connection with the selected NG_RAN. In some example implementations, during the RRC connection setup process, the UE may further inform the NG_RAN node of the existence of the RLF report.

In step 5, the UE may send the RLF report via a communication session based on the RRC connection established between the UE and the selected NG_RAN. The NG_RAN node subsequent receives the RLF report.

In step 6, the NG_RAN node performs analysis of and information extraction from the received RLF report. Such analysis or information extraction may enable the NG_RAN to obtain the various information items contained in the RLF report and described above in relation to step 3 of FIG. 5. The NG_RAN thus may identify and ascertain the MCG and/or SCG failures indicated in the RLF report.

The NG_RAN node distinguishes this scenario from the ordinary RLF failure scenario through information 1, 2, 3, and/or 4 of the information items in the RLF report described above for step 3 of FIG. 5. The NG_RAN's identifier information may also be included in the RLF report. In Step 6, the receiving NG-RAN node can particularly distinguish the Fast MCG failure scenario from other RLF scenarios and locate the faulty MN or SN by parsing the RLF report information items described above.

Upon identifying faulty MN and/or SN, the NG_RAN node may then transmit the corresponding failure information to the MN and/or directly or indirectly to the SN, via, for example the Xn communication interfaces. For indirectly informing the SN of the failure information to the SN, the NG_RAN node may choose to transmit such failure information via the MN.

For example, as shown by the alternative procedure 1 in FIG. 5, once the NG_RAN node identifies that the MN among the one or more faulty entities, the NG_RAN node may in step 7 choose to only send the various failure information extracted from the RLF report to the MN via, for example, the Xn interface therebetween. The failure information may be sent from the NG_RAN node to the MN as a Failure Indication message or an RLF report message. In some implementations, the NG_RAN node may simply relay the RLF report to the MN.

The MN, upon receiving the failure information, may perform its own failure analysis to analyze failure cause(s) at step 7.1 by extracting the failure information items from the RLF report. The extracted information items may include at least one of the information items of the RLF report listed above in relation to step 3. The MN may thus identify a list of faulty network nodes. If MN identity itself as at least one of the faulty entities with failed radio link to the UE, then it may determine a self-optimization to be performed according to the failure information and other network conditions. The self-optimization at the MN may involve adjustment of various network configuration, resource allocation, radio power levels, and the like.

If the MN further identifies the SN as at least one of the faulty entities, it may then assemble the relevant failure information and transmit such failure information to the SN via, for example, the Xn interface between the MN and the SN, as shown in step 8. In some implementations the MN may send the failure information to the SN by reusing the Failure Indication message or as an RLF report. In some implementations, the MN may simply relay the RLF report received from the NG_RAN node to the SN.

In some example implementations, messaging scheme within the dual connectivity (DC) procedure may be used for transmitting the failure information/failure indication message/RLF from the MN to the SN. For example, an S-NODE MODIFICATION REQUEST message for DC may be used for transmitting link failure information to the SN by adding a new information item (IE) in the S-NODE MODIFICATION REQUEST message. The new information IE may be implemented in the form of a container in the S-NODE MODIFICATION REQUEST message in DC procedure, referred to as a UE RLF Report Container. The various example information fields are shown below.

TABLE I

| | | | | Assigned |
|---|---|---|---|---|
| IE/Group | Pres- | | Criti- | Criti- |
| Name | ence | Semantics description | cality | cality |
| Message | M | | YES | reject |
| Type | | | | |
| M-NG-RAN | M | Allocated at the M-NG-RAN | YES | reject |
| node UE | | node | | |
| XnAP ID | | | | |
| S-NG-RAN | M | Allocated at the S-NG-RAN | YES | reject |
| node UE | | node | | |
| XnAP ID | | | | |
| Cause | M | | YES | ignore |
| UE RLF | O | nr-RLF-Report-r16 IE contained | YES | ignore |
| Report | | in the UEInformationResponse | | |
| Container | | message or RLF-Report-r9 IE | | |
| | | contained in the | | |
| | | UEInformationResponse | | |
| | | message | | |

The SN, upon receiving the failure information, may then parse the failure information (e.g., Failure Indication message/RLF report) transmitted from the MN and extract the various information items in step 8.1 of FIG. 5. The extracted information items, for example, may include one or more of the failure information items list above for step 3. Based on the failure information extracted for the SN or SCG (if any, such as items 4 or 5 in the list of failure information items of the RLF report in step 3), the SN may further proceed to determining a self-optimization to be performed according to the failure information items and other network conditions. The self-optimization at the SN may involve adjustment of various network configuration, resource allocation, radio power levels, and the like.

For another example, the NG_RAN node may choose only to send the Failure Indication message/RLF report to the SN via the Xn interface therebetween when the NG_RAN identifies that the SN is at least one of the faulty network entities. The format and content for such Failure indication message/RLF report may be similar to step 7 of alternative procedure 1 above. The SN may then perform its self-optimization procedure in parallel to or in series with analyzing the Failure Indication message/RLF to determine whether the MN is faulty and, if so, sending all or part of the Failure Indication message/RLF to the MN.

In some implementations, as shown by the alternative procedure 2 of FIG. 5, the NG_RAN node may send the RLF report of Failure Indication message directly to wherever the faulty entities are according to its failure detection or analysis based on the received RLF report in step 6. For example, the NG_RAN node, upon determining that the MN is one of the faulty network entities, may send the failure indication message/RLF to the MN via the Xn interface therebetween (step 7). The NG_RAN node, upon determining that the SN is one of the faulty network entities, may separately send a direct failure indication message/RLF to the SN via the Xn interface between the NG_RAN node and the SN (step 8). Each of the MN and SN may then analyze failure causes (step 7.1 and step 8.1) and proceed to performing self-optimization based on the extracted failure information (such as any one of the information items list above for the RLF report in step 3) and other network conditions. For example, the self-optimization of the MN network configuration may be based on information items 1-3 above whereas the self-optimization of the SN network configuration may be based on information items 4-5 above for the RLF.

### Embodiment 2

In some variation to the example implementation of FIG. 5, upon detecting the SCG or SN failure at step 3, the UE may generate SCG/SN failure information items. But rather than including these SCG/SN failure information items in a new or overwritten RLF report, the UE may instead generate a specific failure report, referred to as an MCG recovery report having newly defined VarFastMCGRecovery-Report variable of the UE. Such a report may be transmitted in a similar manner to the intermediate NG_RAN and subsequently processed similarly to the RLF report, except that the MCG recovery report represents a separate report message from the normal RLF report.

This example implementation is illustrated in FIG. 6. Detailed description of the steps in the procedure illustrated in FIG. 6 can be found in the disclosure for FIG. 5 above, except that the RLF report of FIG. 5 is referred to as fast MCG recovery report in FIG. 6. The fast MCG recover report, for example, may include similar failure information items listed above for step 3 of FIG. 5, except that it is now a report separate from the normal RLF report. The rest of the procedures in FIG. 5 may be adapted for FIG. 6 for failure information messaging, transmission, and analysis, and for self-optimization at the MN and/or the SN.

In some example implementations of step 7 (for alternative procedure 1 or alternative procedure 2) and step 8 (for alternative procedure 2) of FIG. 6, the corresponding Failure Indication message from the NG_RAN to the MN or SN in the corresponding procedures of FIG. 5 may be implemented as a special FastMCGFailure Indication message. Like the Failure Indication message of FIG. 5, the FastMCGFailure Indication message sent from the NG_RAN node to the MN or the SN may include any one of the failure information items listed above for step 3 of FIG. 5. In the implementation of FIG. 6, the Fast MCG recovery INDICATION message from the NG_RAN node to the MN or the SN may be configured as a separate message constructed specifically for the fast MCG link recovery procedure. The transmission of such a message by the NG_RAN node or the reception of such a message by the MN or the SN may implicitly indicate that an RRC re-establishment attempt has been made between the UE and the NG_RAN node, and that the Fast MCG recovery Report indicating link failures has been received at the NG_RAN node from the UE. The corresponding message type may be defined as an Ng_Ran to Ng_Ran messaging and may include the UE Fast MCG recoveryReport as an IE, e.g., a container IE. An example format for such an Ng_Ran to Ng-Ran FastMCGFailure Indication message constructed as an RRC message is shown below:

TABLE II

| | | | Assigned |
|---|---|---|---|
| | Pres- | Criti- | Criti- |
| IE/Group Name | ence | cality | cality |
| Message Type | M | YES | ignore |
| CHOICE Initiating condition | M | YES | reject |
| >RRC Reestab | | | |
| >>>RRC Reestab Reporting with Fast | | | |
| MCG recovery Report | | | |
| >>>>UE Fast MCG recovery Report | M | — | |
| Container | | | |
| >RRC Setup | | | |
| >>CHOICE RRC Setup Initiated | M | — | |
| Reporting | | | |
| >>>RRC Setup Reporting with Fast MCG | | | |
| recovery Report | | | |
| >>>>UE Fast MCG recoveryReport | M | — | |
| Container | | | |

With respect to the FastMCGFailure Indication message shown in step 8 of the alternative procedure 2 in FIG. 6, it may adopt a messaging scheme between the MN and SN for DC procedure, similar to the implementation of the corresponding step in FIG. 5 as described above. For example, the S-NODE MODIFICATION REQUEST message used in the DC procedure may be adapted for the purpose of this MN-to-SN FastMCGFailure Indication messaging. The S-NODE MODIFICATION REQUEST message may be particularly adapted to include an IE (e.g., a container IE) for the FastMCG recovery report (and the various failure information items included therein), similar to Table I above, with the RLF Report container replaced by the FastMCG recovery report:

TABLE III

| | | | | Assigned |
|---|---|---|---|---|
| | Pres- | | Criti- | Criti- |
| IE/Group Name | ence | Semantics description | cality | cality |
| Message Type | M | | YES | reject |
| M-NG-RAN node | M | Allocated at the M- | YES | reject |
| UE XnAP ID | | NG-RAN node | | |
| S-NG-RAN node | M | Allocated at the S-NG- | YES | reject |
| UE XnAP ID | | RAN node | | |
| Cause | M | | YES | ignore |
| UE Fast MCG | O | Defined in TS 38.331 | YES | ignore |
| recovery Report | | | | |
| Container | | | | |

### Embodiment 3

In some other circumstances, the UE may determine that the MCGFailureInformation, after being transmitted to the SN in step 3 of FIG. 4, has been successfully received by the SN based on, for example, that the radio link between the UE and the SN has been normal during the transmission of the MCGFailureInformation message and/or that an ACK to the MCGFailureInformation message has been received from the SN.

However, network failure may occur after such successful transmission of the MCGFailureInformation from the UE to the SN. For example, the radio link between UE and the SN may fail after the successful transmission of MCGFailureInformation from the UE to the SN. For another example, the Xn connection between the SN and MN may experience issues. Any of these failures may cause the message from the MN in response to the MCGFailure information to become undeliverable to the UE as a result of a breakage of any one of the SN-to-MN link (e.g., Xn), MN-to-SN link (e.g., Xn), and SN-to-UE link (e.g., radio link) in steps 4-6 of FIG. 4.

In particular, the UE may detect a radio link failure between the UE and the SCG or SN after the MCGFailureInformation has been successfully transmitted to the SN. Because of such a failure, the UE would determine that the MN response would be undeliverable to the UE regardless of whether the MN is able to receive the MCGFailureInformation and perform proper self-optimization of its network configurations or not.

Under such a condition, the UE may not be sure as to whether the MCGFailure information has been successfully provided to the MN by the SN prior to the expiration of the T 316 timer. Correspondingly, the UE may not be certain as to whether the MN is able to perform proper self-optimization based on the MCG failure.

In some example implementations under such a condition, the RLF report or the fast MCG recovery report as described in step 3 of FIG. 5 or FIG. 6 may be constructed to include addition information items to indicate the occurrence of such a SCG or SN failure condition. In particular, instead of merely indicating a failure of the SCG or SN radio link, additional information item(s) may be included to indicate that the SCG or SN radio link failure was detected after the successful transmission of the MCGFailureInformation message from the UE to the SN via the radio interface. The purpose for including such information item(s) in the RLF report or the fast MCG recovery report is to avoid having the MN to repeat performing self-optimization. For example, because the SN has already successfully received the MCGFailureInformation message at step 3 of FIG. 4, FIG. 5, or FIG. 6, and that the SN-to-MN link (e.g., Xn) may be normal, the MN might have already received the MCGFailureInformation message from the SN and may have already properly performed its self-optimization procedure. If the indication of successful transmission of the MCGFailureInformation message from the UE to the SN is not included in the RLF report or the fast MCG recovery report, the MN, upon receiving such report following the procedure of FIG. 5 or FIG. 6 may view the report as triggering another self-optimization procedure that may be unknowingly duplicative to the MN. The inclusion of such an indication in the RLF report or the fast MCG recovery report thus would inform the MN of link failures in a manner such that the MN can avoid duplicative self-optimization and perform self-optimization according to the RLF report or the fast MCG recovery report only if such self-optimization has not already been performed.

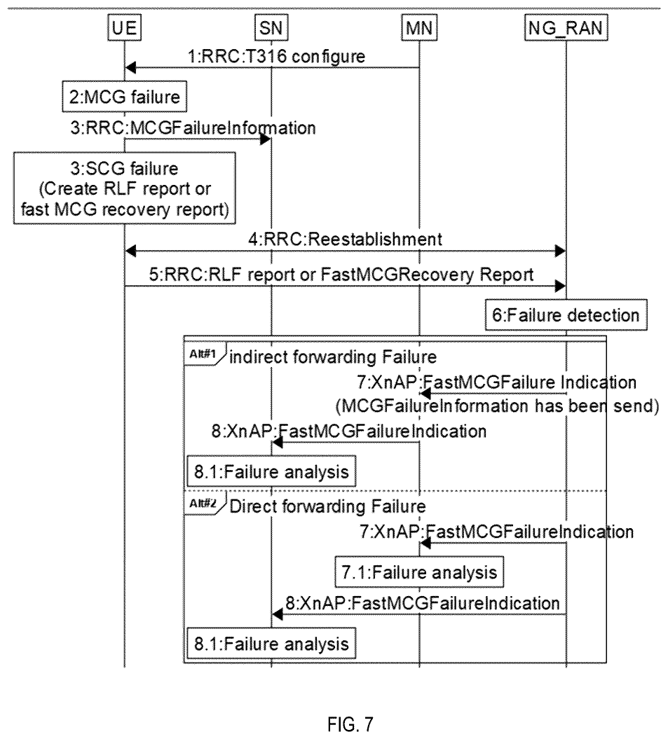

Such an example implementation under the condition that the SCG or SN failure is detected after successful transmission of the MCGFailure Information message from the UE to the SN is illustrated in FIG. 7. These steps are similar to those of FIG. 5 or FIG. 6 (for either the RLF report implementation or the fast MCG recovery report implementation). The main difference is that the information items associated with the successful transmission of the MCGFailureInformation message from the UE to the SN are included in the RLF report or the fast MCG recovery report, as described above. Specifically, the link failure information in the RLF report or the fast MCG recover report may contain any one of the information items described above in step 3 of FIG. 4 above including:
1: Cell information of the failed MN (e.g., identifier information the primary cell of the MCG, referred to as failedPCellId);
2: Information of the failed SN cell (e.g., identifier information of the primary cell in the SCG, referred to as failedPScellID);
3: MCGFailureInformation information, information associated with the MCG failure, such as a type of the MCG link failure, referred to as failureType, carrier frequency information, referred to as measResultFreqList information, and the like;
4: SN cause value for radio link failure for indicating the SCG failure type, referred to as SCGfailureType; or
5: SCG PScell measurement information in case of SCG failure, referred to as MeasResultSCG-Failure;
   and additional include:
6: An indication that the MCGFailureInformation has been successfully sent from the UE to the SN.

Correspondingly, the other different between the implementation of FIG. 7 and FIG. 5 and FIG. 6 is that indication that the MCGFailureInformation has been successfully sent from the UE to the SN is also included in the MCGFailureInformation Indication message or the FastMCGFailure Indication message of step 7, and that the MN, upon receiving the message and extracting that indication information, can then determine whether the self-optimization would be duplicative or not, and perform the self-optimization if the MCGFailureinformation has not been previously received from the SN and that the corresponding self-optimization has not been performed yet.

For example, the Fast MCGFailureInformation Indication message may be constructed similar to that in Table II above but additionally include the indication that the MCGFailureInformation has been successfully sent from the UE to the SN:

TABLE IV

| | Pres- | Semantics | | Assigned |
|---|---|---|---|---|
| IE/Group Name | ence | description | Criticality | Criticality |
| Message Type | M | | YES | ignore |
| CHOICE Initiating | M | | YES | reject |
| condition | | | | |
| >RRC Reestab | | | | |
| >>>RRC Reestab | | | | |
| Reporting with Fast | | | | |
| MCG recovery Report | | | | |
| >>>>UE Fast MCG | M | | — | |
| recovery Report | | | | |
| Container | | | | |
| >>>>MCGFailure | O | Whether the | | |
| Information indicator | | MCGFailure | | |
| | | Information has | | |
| | | been sent to the | | |
| | | SN | | |
| >RRC Setup | | | | |
| >>CHOICE RRC | M | | — | |
| Setup Initiated | | | | |
| Reporting | | | | |
| >>>RRC Setup | | | | |
| Reporting with Fast | | | | |
| MCG recovery Report | | | | |
| >>>>UE Fast MCG | M | | — | |
| recoveryReport | | | | |
| Container | | | | |

Further in steps 8 of the indirect alternative procedure 1 or the direct alternative procedure 2 of FIG. 7, the FastMCGFailureIndication message implemented in a manner such as a DC procedure message from the MN to the SN may likewise additionally include the indication information item that the MCGFailureInformation has been successfully sent from the UE to the SN.

### Embodiment 4

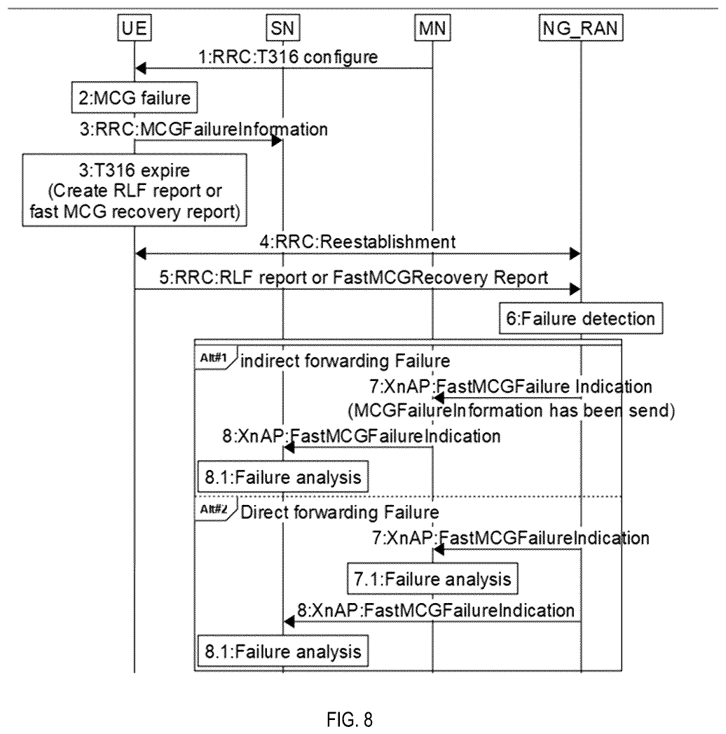

In some other circumstances, after the UE successfully sends the MCGFailureInformation message to the SN in step 3 of FIG. 4, SCG radio link may be normal (no failure) but the T 316 timer may have expired prior to any response from the MN is received at the UE. Such situation may be a result of, for example, an SN-to-MN communication failure. Example procedure for enabling T 316 timeout reporting procedure and self-optimization of the various network nodes are shown in FIG. 8. In this particular situation, when the UE generates RLF report or FastMCGRecovery report, the link failure information items may contain at least one of the following:
1: Cell information of the failed MN (e.g., identifier information the primary cell of the MCG, referred to as failedPCellId);
2: T 316 timeout SN cell information (e.g., identifier information of the primary cell in the SCG associated with the expired T316 timer, referred to as ExpiredPScellID);
3: MCGFailureInformation information, information associated with the MCG failure, such as a type of the MCG link failure, referred to as failureType, carrier frequency information, referred to as measResultFreqList information, and the like;
4: Cause value (T316 expiration);
5: SCG PScell measurement information upon T316 timeout (MeasResultSCG-T316 expiration).

Other aspects of the example procedure in FIG. 8 are similar to FIG. 7 for embodiment 3, and are thus not qualitatively described herein.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a wireless terminal device in communication with a Master Node (MN) associated with a Master Cell Group (MCG) and a Secondary Node (SN) associated with a Secondary Cell Group (SCG), comprising:
instantiating a fast MGC failure recovery mode in response to receiving an MCG failure recovery configuration from the MN;
detecting an MCG radio link failure;
determining a no-MN-response condition associated with informing the MN of the MCG radio link failure via the SN;
generating a reporting data structure associated with the MCG link failure and the no-MN-response condition; and
transmitting the reporting data structure to an intermediary wireless access network node for relaying the MCG link failure and the no-MN-response condition to the MN or the SN.

2. The method of claim 1, wherein the no-MN-response condition comprises a detection of an SCG radio link failure between the wireless terminal device and the SN prior to the wireless terminal device successfully informing the SN of the MCG radio link failure.

3. The method of claim 2, wherein the reporting data structure comprises at least one of:
a first cell identification of the MN;
a second cell identification of the SN;
a first failure information associated with the MCG radio link failure; or
a second failure information associated with the SCG radio link failure.

4. (canceled)

5. The method of claim 3, wherein the first failure information comprises at least one of an MCG link failure type or a list of MCG frequency measurements and the second failure information comprises at least one cell measurement associated with the SN.

6. (canceled)

7. The method of claim 3, wherein the reporting data structure is included as an Information Element (IE) in a UE Radio Link Failure (RLF) report message, or in the UE RLF report message as a container, or in a fast MCG link recovery report message separate from a UE RLF report message.

8.-10. (canceled)

11. The method of claim 1, wherein the no-MN-response condition comprises a detection of an SCG radio link failure between the wireless terminal device and the SN after the wireless terminal device successfully informs the SN of the MCG radio link failure and wherein the reporting data structure comprises:
an indication that the wireless terminal device has successfully informed the SN of the MCG radio link failure; and
at least one of:
a first cell identification of the MN;
a second cell identification of the SN;
a first failure information associated with the MCG radio link failure; or
a second failure information associated with the SCG radio link failure.

12. (canceled)

13. The method of claim 11, wherein the first failure information comprises at least one of an MCG link failure type or a list of MCG frequency measurements and the second failure information comprises at least one cell measurement associated with the SN.

14. The method of claim 11, wherein the reporting data structure is included as:
an Information Element (IE) or a container in a UE Radio Link Failure (RLF) report message; or
a fast MCG link recovery report message separate from the UE RLF report message.

15. The method of claim 1, wherein:
the MCG failure recovery configuration comprises a timer having a preconfigured time length;
the method further comprising transmitting a failure message indicating the MCG radio link failure to the SN; and
the no-MN-response condition comprises an expiration of the timer prior to receiving a response to the failure message from the MN.

16. The method of claim 15, wherein the reporting data structure comprises:
an indication that the timer has expired; and
at least one of:
a first cell identification of the MN;
a second cell identification of the SN;
a failure information associated with the MCG radio link failure; or
a cell measurement of the SN upon the expiration of the timer.

17. (canceled)

18. The method of claim 16, wherein the failure information comprises at least one of an MCG link failure type or a list of MCG frequency measurements.

19. The method of claim 16, wherein the reporting data structure is included as:
an Information Element (IE) or a container in a UE Radio Link Failure (RLF) report message; or
a fast MCG link recovery report message separate from the UE RLF report message.

20. A method performed by a wireless access network node in assisting a wireless terminal device with reporting a link failure condition, the wireless terminal device being in communication with a Master Node (MN) associated with a Master Cell Group (MCG) and a Secondary Node (SN) associated with a Secondary Cell Group (SCG), the method comprising:
receiving from the wireless terminal device a link failure reporting data item, the link failure reporting data item indicating at least one of an MCG radio link failure associated with a radio communication path between the wireless terminal device and the MN or a no-MN-response condition associated with informing the MN of the MCG radio failure via the SN by the wireless terminal device; and
informing the MN or the SN of the MCG radio link failure or the no-MN-response condition.

21. (canceled)

22. The method of claim 20, wherein the no-MN-response condition comprises a detection of a SCG radio link failure between the wireless terminal device and the SN prior to the wireless terminal device successfully informing the SN of the MCG radio link failure and wherein the link failure reporting data item comprises at least one of:
a first cell identification of the MN;
a second cell identification of the SN;
a first failure information associated with the MCG radio link failure; or
a second failure information associated with the SCG radio link failure.

23. The method of claim 22, wherein the first failure information comprises at least one of an MCG link failure type or a list of MCG frequency measurements and the second failure information comprises at least one cell measurement associated with the SN.

24. The method of claim 22, wherein the link failure reporting data item is included as:
an Information Element (IE) or a container in a UE Radio Link Failure (RLF) report message; or
a fast MCG link recovery report message separate from the UE RLF report message.

25. (canceled)

26. The method of claim 20, wherein the no-MN-response condition comprises a detection of an SCG radio link failure between the wireless terminal device and the SN after the wireless terminal device successfully informs the SN of the MCG radio link failure and wherein the link failure reporting data item comprises:
an indication that the wireless terminal device has successfully informed the SN of the MCG radio link failure; and
at least one of:
a first cell identification of the MN;
a second cell identification of the SN;
a first failure information associated with the MCG radio link failure; or
a second failure information associated with the SCG radio link failure.

27. The method of claim 26, wherein the first failure information comprises at least one of an MCG link failure type or a list of MCG frequency measurements and the second failure information comprises at least one cell measurement associated with the SN.

28. (canceled)

29. The method of claim 20, wherein the no-MN-response condition comprises an expiration of a timer at the wireless terminal device having a preconfigured time length prior to the wireless terminal device receiving a response from the MN to a failure message sent by the wireless terminal device to the SN for indicating to the SN the MCG radio link failure and wherein the link failure reporting data item comprises:
an indication that the timer has expired; and
at least one of:
a first cell identification of the MN;
a second cell identification of the SN;
a failure information associated with the MCG radio link failure; or
a cell measurement of the SN upon the expiration of the timer.

30. The method of claim 20, wherein informing the MN or the SN of the MCG radio link failure or the no-MN-response condition comprises:
informing the MN of the MCG radio link failure and the no-MN-response condition; and
enabling the MN to inform the SN of at least the no-MN-response condition or separately informing the SN of at least the no-MN-response condition.

31. (canceled)

32. The wireless terminal device claim 1, comprising a memory for storing instructions and a processor for executing the instructions to implement claim 1.

33. (canceled)
